(19) United States
(12) Patent Application Publication
(10) Pub. No.: US 2010/0147684 A1
(43) Pub. Date: Jun. 17, 2010

(54) ULTRA-SENSITIVE GAS SENSOR USING OXIDE SEMICONDUCTOR NANOFIBER AND METHOD OF FABRICATING THE SAME

(75) Inventors: Jin Ah PARK, Gyeongsangnam-do (KR); Su Jae Lee, Daejeon (KR); Jae Hyun Moon, Daejeon (KR); Tae Hyoung Zhung, Daejeon (KR)

Correspondence Address: RABIN & Berdo, PC, 1101 14TH STREET, NW, SUITE 500, WASHINGTON, DC, 20005, US

(73) Assignee: ELECTRONICS AND TELECOMMUNICATIONS RESEARCH INSTITUTE, Daejeon (KR)

(21) Appl. No.: 12/503,647

(22) Filed: Jul. 15, 2009

(30) Foreign Application Priority Data
Dec. 12, 2008 (KR) 10-2008-0126594

(51) Int. Cl. G01N 27/26; B05D 5/12

(52) U.S. Cl. 204/431; 427/123

(57) ABSTRACT

An ultra-sensitive gas sensor using semiconductor oxide nanofibers and a method of fabricating the same are provided. The gas sensor includes an insulating substrate, a metal electrode formed on the insulating substrate, and a semiconductor metal oxide nanofibers layer formed on the metal electrode and having nanoparticles of high sensitivity coated thereon. The method of fabricating a semiconductor oxide nanofibers gas sensor includes fabricating an oxide using a solution for electrospinning, electrospinning the solution, performing an annealing process to form an oxide semiconductor nanofiber, and partially coating a nano-sized metal oxide or metal catalyst particle having high sensitivity to a specific gas on a surface of the nanofiber having a large specific surface area. As a result, a semiconductor oxide nanofibers gas sensor having ultra sensitivity, high selectivity, fast response and long-term stability can be fabricated.

### CROSS-REFERENCE TO RELATED APPLICATION

This application claims priority to and the benefit of Korean Patent Application No. 10-2008-0126594, filed Dec. 12, 2008, the disclosure of which is incorporated herein by reference in its entirety.

### BACKGROUND

1. Field of the Invention

The present invention relates to an ultra-sensitive gas sensor using semiconductor oxide nanofibers and a method of fabricating the same. More particularly, the present invention relates to an ultra-sensitive gas sensor using semiconductor oxide nanofibers having characteristics of ultra sensitivity, high selectivity, fast responsivity, and long-term stability by coating a nano-sized oxide material having high sensitivity to a specific gas on the nanofibers of a large specific surface area and a method of fabricating the same.

2. Discussion of Related Art

Since an semiconductor oxide for gas sensing exhibits superior reactivity, stability, durability and productivity to a reactive gas, the oxide semiconductor is being researched and developed in the form of a bulk, a thick film, a chip, and a thin film.

The gas sensing characteristics that the semiconductor oxide-based gas sensor has with respect to the reactive gas result from changed electrical characteristics of the semiconductor oxide by a reversible chemical reaction that is generated when the reactive gas is adsorbed on and desorbed from an oxide surface.

In order to improve the gas sensing characteristics of the semiconductor oxide-based gas sensor, development of an semiconductor oxide having superior reactivity and improvement of fabricating processes have been concentrated on. In particular, an effort to fabricate an oxide semiconductor thin film gas sensor having a two- or three-dimensional structure in which a surface area to volume ratio and porosity to volume is great has been made using a crystallized oxide sensor material having a diameter of several nm to several hundreds of nm.

In addition, various organic/inorganic fusion processes, including a process using a polymer template, have been attempted.

However, since the oxide semiconductor thin film gas sensor has structural limits including an interfacial reaction between an insulating support substrate and an oxide for gas sensing, and a limited increase in a reaction area, a new process needs to be introduced. In this regard, currently, attempts to fabricate a gas sensor using oxide nanofibers are being actively made.

Electrospinning is suggested as one of the best methods of fabricating semiconductor oxide nanofibers due to low manufacturing costs, a simple process, and high productivity.

In the fabrication of nanofibers using electrospinning, semiconductor oxide nanofibers are fabricated by electrospinning a composite solution in which a metal oxide precursor, a polymer and a solvent are mixed, and annealing the electrospun results. The fabricated metal oxide nanofibers are oxide microfibers consisting of crystallized oxides, and are formed to a diameter of several nm to several hundreds of nm and a length of several mm.

The semiconductor oxide nanofibers have a strong shape, and provide a much higher surface area to volume ratio and porosity to volume than a thin film. Furthermore, process variable, parts and devices of electrospinning can be adjusted in a simple manner to fabricate finer nanofibers. That is, a diameter of the nanofiber may be formed to be similar to a width of a depletion layer. Therefore, applying a new one-dimensional gas sensor material exhibiting high sensitivity and high response/recovery rate even to the concentration of an extremely small amount of a reactive gas is being actively attempted and researched.

It is reported that among semiconductor oxide nanofibers fabricated by electrospinning, a TiO₂ nanofibers-based gas sensor exhibits high gas sensitivity even at a ppb level reactive gas concentration.

However, semiconductor oxide materials used to the nanofibers-based gas sensor exhibiting high sensitivity are limited to TiO₂ and a response/recovery rate thereof to a reactive gas is not high. Moreover, in order to improve such characteristics, using noble metal catalysts is being attempted and researched. However, using the noble metal catalysts results in increased manufacturing costs.

As described above, an semiconductor oxide nanofibers-based sensor has a much larger specific surface area than bulk, thin film and thick film type sensors, and an ultra-sensitive and high functional sensor capable of sensing gases harmful to the environment can be fabricated using such characteristics. However, in spite of such advantages of nanofibers, the sensor for sensing gases harmful to the environment using nanofibers has not been applied practically. This is because semiconductor oxide nanofiber materials exhibiting significantly improved reactivity to a reactive gas are limited to TiO₂ and a response and recovery rate thereof is insufficient. Moreover, noble metal catalysts used to improve reactivity lead to a rise in manufacturing costs.

During current research into a method to overcome the problems of the conventional art using the nanofibers having characteristics of a large specific surface area, the following was observed: When nano-sized metal oxide particles or metal catalyst particles having high sensitivity to a specific gas are partially coated on semiconductor oxide nanofibers having a large specific surface area, a gas sensor exhibiting ultra sensitivity, fast response, high selectivity and long-term stability can be obtained, and thus the present invention was completed.

### SUMMARY OF THE INVENTION

The present invention is directed to a gas sensor using semiconductor oxide nanofibers on which nano-sized metal oxide or metal catalyst particles having high sensitivity to a specific gas are coated.

The present invention is also directed to a method of fabricating a gas sensor using semiconductor oxide nanofibers on which nano-sized metal oxide or metal catalyst particles having high sensitivity to a specific gas are coated.

One aspect of the present invention provides an ultra-sensitive gas sensor including: an insulating substrate; a metal electrode formed on the insulating substrate; and a semiconductor oxide nanofiber layer formed on the metal electrode and having nanoparticles of high sensitivity coated thereon.

The insulating substrate may be selected from the group consisting of an oxide single crystal substrate, a ceramic substrate, a silicon substrate on which an insulating layer is formed, and a glass substrate.

The metal electrode may be formed of one or more elements selected from the group consisting of Pt, Pd, Ag, Au, Ni, Ti, Cr, Al, Cu, Sn, Mo, Ru and In.

The oxides constituting the semiconductor oxide nanofiber layer may include one or more oxides selected from the group consisting of ABO₃-type perovskite oxides (BaTiO₃, metal-doped BaTiO₃, SrTiO₃, and BaSnO₃), ZnO, CuO, NiO, SnO₂, TiO₂, CoO, In₂O₃, WO₃, MgO, CaO, La₂O₃, Nd₂O₃, Y₂O₃, CeO₂, PbO, ZrO₂, Fe₂O₃, Bi₂O₃, V₂O₅, VO₂, Nb₂O₅, Co₃O₄ and Al₂O₃.

The nanoparticle coated on a surface of the nanofiber layer may be a nano-sized metal oxide particle or metal catalyst particle having high sensitivity to a specific gas. Here, the metal oxide may include one or more oxides selected from the group consisting of ABO₃-type perovskite oxides (BaTiO₃, metal-doped BaTiO₃, SrTiO₃, and BaSnO₃), ZnO, CuO, NiO, SnO₂, TiO₂, CoO, In₂O₃, WO₃, MgO, CaO, La₂O₃, Nd₂O₃, Y₂O₃, CeO₂, PbO, ZrO₂, Fe₂O₃, Bi₂O₃, V₂O₅, VO₂, Nb₂O₅, Co₃O₄ and Al₂O₃, and the metal may include one or more elements selected from the group consisting of Pt, Pd, Ag, Au, Ti, Cr, Al, Cu, Sn, Mo, Ru and In.

Another aspect of the present invention provides a method of fabricating an ultra-sensitive gas sensor including: forming a metal electrode on an insulating substrate; electrospinning a composite solution in which a metal oxide, a polymer material and a solvent are mixed on the metal electrode to form an oxide/polymer composite nanofiber layer; performing a first annealing process on the composite nanofiber layer and removing the solvent; performing a second annealing process on the composite nanofiber layer from which the solvent is removed to form an oxide semiconductor nanofiber layer; coating nanoparticles on a surface of the oxide semiconductor nanofiber layer; and performing a third annealing process on the semiconductor oxide nanofiber layer on which the nanoparticles are coated.

The metal oxide constituting the composite solution may include one or more oxides selected from the group consisting of ABO₃-type perovskite oxides (BaTiO₃, metal-doped BaTiO₃, SrTiO₃, and BaSnO₃), ZnO, CuO, NiO, SnO₂, TiO₂, CoO, In₂O₃, WO₃, MgO, CaO, La₂O₃, Nd₂O₃, Y₂O₃, CeO₂, PbO, ZrO₂, Fe₂O₃, Bi₂O₃, V₂O₅, VO₂, Nb₂O₅, Co₃O₄, and Al₂O₃, precursors, the polymer may include one or more materials selected from the group consisting of polyvinyl phenol (PVP), polyvinyl pyrrolidone (PVP), polyvinyl alcohol (PVA), polyvinyl acetate (PVAc), polystyrene (PS), polyethylene oxide (PEO), polyether urethane (PU), polycarbonate (PC), poly-L-Lactides (PLLA), polyvinyl carbazole (PVC), polyvinyl chloride (PVC), polycaprolactam, polyethylene terephthalate (PET), and polyethylene naphthalate (PEN), and the solvent may include one or more materials selected from the group consisting of ethanol, acetone, dimethylformamide (DMF), tetrahydrofuran (THF), isopropyl alcohol (IPA), water, chloroform, formic acid, diethyl formamide (DEF), dimethylacetamide (DMA), dichloromethane, toluene, and acetic acid.

The first annealing process may be performed around a glass transition temperature of a polymer material, the second annealing process may be performed at a temperature of about 300 to about 800° C., and the third annealing process may be performed at a temperature of about 300 to about 600° C.

The nanoparticle coated on the nanofiber layer may be a nano-sized metal oxide or metal catalyst particle, and may be coated on a surface of the semiconductor oxide nanofiber layer in a thin film or dot form through a physical or chemical deposition means.

The nano-sized metal oxide may include one or more oxides selected from the group consisting of ABO₃-type perovskite oxides (BaTiO₃, metal-doped BaTiO₃, SrTiO₃, and BaSnO₃), ZnO, CuO, NiO, SnO₂, TiO₂, CoO, In₂O₃, WO₃, MgO, CaO, La₂O₃, Nd₂O₃, Y₂O₃, CeO₂, PbO, ZrO₂, Fe₂O₃, Bi₂O₃, V₂O₅, VO₂, Nb₂O₅, Co₃O₄ and Al₂O₃, and the nano-sized metal may include one or more elements selected from the group consisting of Pt, Pd, Ag, Au, Ti, Cr, Al, Cu, Sn, Mo, Ru and In.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 is a perspective view of an ultra-sensitive gas sensor using semiconductor oxide nanofibers according to an exemplary embodiment of the present invention;

FIG. 2 is a perspective view of an oxide semiconductor nanofiber of cases in which a nanoparticle is coated on a surface of an semiconductor oxide nanofiber in a thin film form (a) and in a dot form (b), respectively according to an exemplary embodiment of the present invention;

FIG. 3 illustrates a process of fabricating an ultra-sensitive gas sensor according to an exemplary embodiment of the present invention;

FIG. 4 is the scanning electron microscope (SEM) images of a surface of an oxide/polymer composite nanofibers according to an exemplary embodiment of the present invention;

FIG. 5 is a SEM image of a surface of an semiconductor oxide (ZnO) nanofiber layer according to an exemplary embodiment of the present invention;

FIG. 6 is an energy dispersive X-ray spectroscopy (EDS) spectrum of the ZnO nanofiber layer according to an exemplary embodiment of the present invention;

FIG. 7 is a graph of a θ-2θ X-ray diffraction pattern of the ZnO nanofiber according to an exemplary embodiment of the present invention;

FIG. 8 is a SEM image of a surface of the SnO₂ nanoparticles coated on the ZnO nanofibers according to an exemplary embodiment of the present invention;

FIG. 9 illustrates a result of an energy dispersive X-ray spectroscopy (EDS) spectrum of the SnO₂ nanoparticles coated on the ZnO nanofibers according to an exemplary embodiment of the present invention;

FIG. 10 is a graph of a θ-2θ X-ray diffraction pattern of the SnO₂ nanoparticles coated on the ZnO nanofibers according to an exemplary embodiment of the present invention;

FIG. 11 is a graph illustrating a change in sensitivity measured according to operating temperature and time of an NO₂ gas sensor according to an exemplary embodiment of the present invention;

FIG. 12 is a graph illustrating a change in sensitivity versus operating temperature of an O₂ gas sensor according to an exemplary embodiment of the present invention;

FIG. 13 is a graph illustrating a change in sensitivity measured according to the NO₂ gas concentration at an operating temperature of 200° C. of an NO₂ gas sensor according to an exemplary embodiment of the present invention; and

FIG. 14 is a graph illustrating a change in sensitivity measured according to the NO₂ gas concentration of an NO₂ gas sensor according to an exemplary embodiment of the present invention.

### DETAILED DESCRIPTION OF EMBODIMENTS

The present invention will be described more fully hereinafter with reference to the accompanying drawings, in which exemplary embodiments of the invention are shown. This invention may, however, be embodied in different forms and should not be construed as limited to the embodiments set forth herein. In the drawings, portions irrelevant to a description of the present invention are omitted for clarity, and like reference numerals denote like elements.

The present invention will be described in detail with reference to the accompanying drawings.

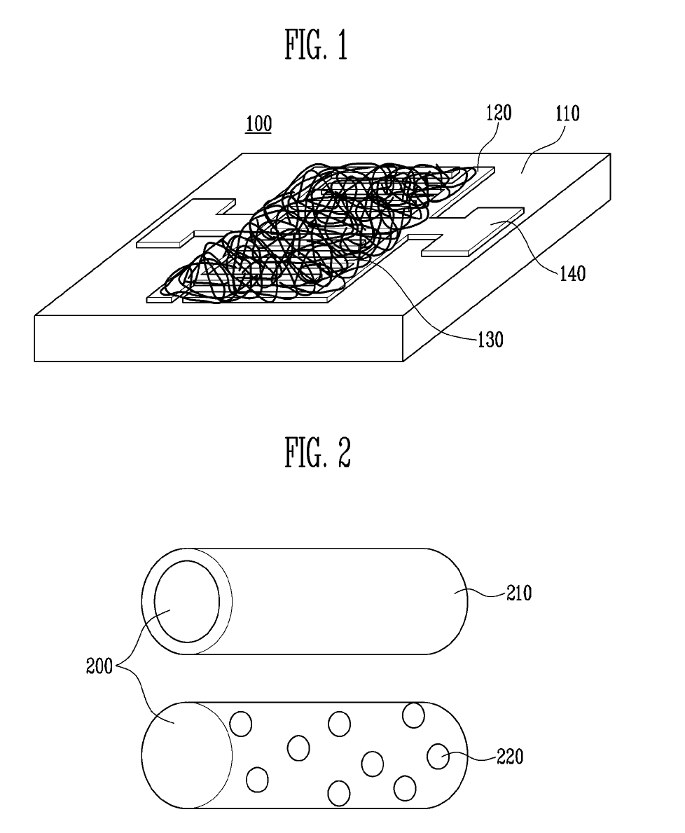

FIG. 1 is a perspective view of an ultra-sensitive gas sensor using semiconductor oxide nanofibers according to one exemplary embodiment of the present invention.

Referring to FIG. 1, an semiconductor oxide nanofibers-based gas sensor 100 includes an insulating substrate 110, a metal electrode 120 formed on the insulating substrate, and an semiconductor oxide nanofibers layer 130 formed on the metal electrode and having nanoparticles coated thereon.

The insulating substrate 110 may be formed to a thickness of 0.1 mm to 1 mm, and may be one selected from the group consisting of an oxide single crystal substrate (e.g., Al₂O₃, MgO, and SrTiO₃), a ceramic substrate (e.g., Al₂O₃ and quartz), a silicon substrate on which an insulating layer is formed (e.g., SiO₂/Si), and a glass substrate.

The metal electrode 120 may be formed of one selected from the group consisting of Pt, Pd, Ag, Au, Ni, Ti, Cr, Al, Cu, Sn, Mo, Ru and In, and may be formed to a thickness of 10 nm to 1000 nm. The metal electrode 120 may include an electrode pad 140 thereon, and the electrode pad 140 may be formed of the same material as the metal electrode 120. However, the metal electrode 120 need not include the electrode pad.

Oxides constituting the semiconductor oxide nanofibers layer 130 may include one or more oxides selected from the group consisting of ABO₃-type perovskite oxides (BaTiO₃, metal-doped BaTiO₃, SrTiO₃, and BaSnO₃), ZnO, CuO, NiO, SnO₂, TiO₂, CoO, In₂O₃, WO₃, MgO, CaO, La₂O₃, Nd₂O₃, Y₂O₃, CeO₂, PbO, ZrO₂, Fe₂O₃, Bi₂O₃, V₂O₅, VO₂, Nb₂O₅, Co₃O₄ and Al₂O₃.

In the semiconductor oxide nanofibers layer 130, each nanofiber may be formed to a diameter of 1 nm to 100 nm. This is because the number of junctions of nanocrystalline particles is increased when the fiber has polycrystalline properties. Accordingly, a specific surface area is increased, so that sensitivity to a specific gas can be increased.

Nanoparticles of high sensitivity are coated on a surface of the semiconductor oxide nanofibers layer 130. The nanoparticles may be nano-sized metal oxide particles or nano-sized metal catalyst particles. The nano-sized metal oxide particles may be coated on the nanofiber layer in a thin film form, and the nano-sized metal catalyst particles may be coated on the nanofiber layer in a dot form.

The nano-sized metal oxide particles may be formed of an oxide having high sensitivity to a specific gas in order to enhance sensitivity and selectivity, and for example, may be formed of one or more oxides selected from the group consisting of ABO₃-type perovskite oxides (BaTiO₃, metal-doped BaTiO₃, SrTiO₃, and BaSnO₃), ZnO, CuO, NiO, SnO₂, TiO₂CoO, In₂O₃, WO₃, MgO, CaO, La₂O₃, Nd₂O₃, Y₂O₃, CeO₂, PbO, ZrO₂, Fe₂O₃, Bi₂O₃, V₂O₅, VO₂, Nb₂O₅, Co₃O₄ and Al₂O₃. Furthermore, a thin film coated as the nano-sized metal oxide particles may be coated to a thickness of a surface space charge layer (100 nm or less) in order to improve electrical responsivity. The metal oxide nanoparticles may be coated on the nanofibers layer 130 in a thin film form using a physical or chemical deposition method such as a pulsed laser deposition method, a sputtering method, a sol-gel method, etc.

Also, the nano-sized metal catalyst particles may be formed of one selected from the group consisting of Pt, Pd, Au, Ag, Ti, Cr, Al, Cu, Sn, Mo, Ru and In, which have high sensitivity to a specific gas, in order to increase high sensitivity and selectivity, and more preferably, may be formed of Pt, Pd, Au or Ag.

The metal catalyst nanoparticles may be partially coated on the nanofiber layer 130, e.g., in a dot form, using a physical deposition method such as a pulsed laser deposition method or a sputtering method.

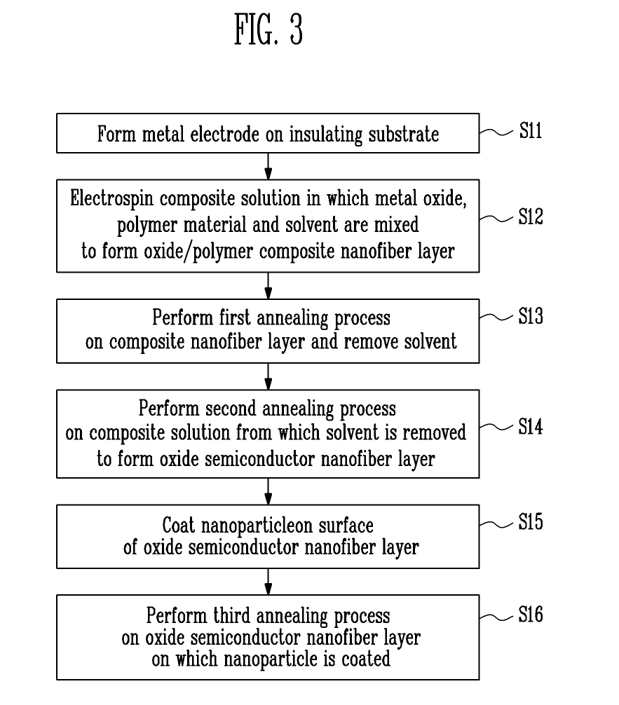

FIG. 2 illustrates a case in which nanoparticles are coated on a surface of the semiconductor oxide nanofibers in a thin film form (a) and in a dot form (b), respectively, according to the present invention. Referring to FIG. 2, nanoparticles 210 are coated on a nanofiber 200 in a thin film form, and nanoparticles 220 are partially coated in a dot form.

FIG. 3 illustrates a process of fabricating an semiconductor oxide nanofibers-based gas sensor according to the present invention.

Referring to FIG. 3, the method includes: forming a metal electrode on an insulating substrate (S11); electrospinning a composite solution in which a metal oxide, a polymer material and a solvent are mixed on the metal electrode to form an oxide/polymer composite nanofibers layer (S12); performing a first annealing process on the composite nanofibers layer and removing the solvent (S13); performing a second annealing process on the composite nanofibers layer from which the solvent is removed to form the semiconductor oxide nanofibers layer (S14); coating nanoparticles having high sensitivity on a surface of the semiconductor oxide nanofibers layer (S15); and performing a third annealing process on the semiconductor oxide nanofibers layer on which the nanoparticles are coated (S16).

In order to fabricate the semiconductor oxide nanofibers-based gas sensor, first, a metal electrode is formed on an insulating substrate (S11). Here, the metal electrode may be formed of one selected from the group consisting of Pt, Pd, Ag, Au, Ni, Ti, Cr, Al, Cu, Sn, Mo, Ru and In, and may be formed to a thickness of 10 nm to 1000 nm using an ordinary method in this field.

Sequentially, the composite solution in which a metal oxide, a polymer material and a solvent are mixed is electrospun to form an oxide/polymer composite nanofibers layer (S12). Here, the composite solution may be obtained by mixing a metal oxide or a metal oxide precursor and a polymer material with a solvent, and may have a viscosity of 1000 cps to 3000 cps to be used for electrospinning. In this case, a weight ratio of the metal oxide, the polymer material and the solvent may be mixed within the range of 5:4:2 to 4:3:1. Also, the polymer material and the solvent may be a combination of a polar polymer and a polar solvent or a non-polar polymer and a non-polar solvent. The composite solution is mixed at room temperature or higher (e.g., 25□ to 100□) and the solution may be stirred for a long time (specifically, three to twenty four hours) to fabricate beadless nanofibers.

ABO₃-type perovskite oxides (BaTiO₃, metal-doped BaTiO₃, SrTiO₃, and BaSnO₃), ZnO, CuO, NiO, SnO₂, TiO₂, CoO, In₂O₃, WO₃, MgO, CaO, La₂O₃, Nd₂O₃, Y₂O₃, CeO₂, PbO, ZrO₂, Fe₂O₃, Bi₂O₃, V₂O₅, VO₂, Nb₂O₅, Co₃O₄ or Al₂O₃ precursors may be used as the metal oxides constituting the composite solution. Further, polyvinylphenol (PVP), polyvinyl alcohol (PVA), polyvinyl acetate (PVAc), polystyrene (PS), polyethylene oxide (PEO), polyether urethane (PU), polycarbonate (PC), poly-L-Lactides (PLLA), polyvinyl carbazole (PVC), polyvinyl chloride (PVC), polycaprolactam, polyethylene terephthalate (PET), or polyethylene naphthalate (PEN) may be used as the polymer, and ethanol, acetone, dimethylformamide (DMF), tetrahydrofuran (THF), isopropyl alcohol (IPA), water, chloroform, formic acid, diethyl formamide (DEF), dimethylacetamide (DMA), dichloromethane, toluene, and acetic acid may be used as the solvent.

The composite solution is placed in an electrospinning device to be spun through an injection nozzle having a diameter of 10 μm to 1 mm. In this case, a voltage of 1 kV to 30 kV is applied to the injection nozzle to spin the composite solution. As a result, the electrospun results are collected on a substrate on a grounded collector, so that a nanofiber formed to a diameter of 1 nm to 100 nm can be obtained.

Afterwards, in order to remove the solvent, a first annealing process is performed (S13). The first annealing process is performed around a glass transition temperature of the polymer material for ten minutes to one hour. As a result, the oxide/polymer composite nanofibers may have a thermally and materially stable and strong network structure between nanofibers. In addition, adhesive properties between the metal electrode and the nanofiber layer can be enhanced. As a result of the first annealing process, the solvent may be completely removed.

Then, a second annealing process is performed for the purpose of removing the polymer material and crystallization (S14). The second annealing process may be performed at a temperature of 500□ or higher, and more preferably, at a temperature of 500□ to 700□ for ten minutes to ten hours, and the semiconductor oxide nanofibers layer is formed as a result of the second annealing process.

Subsequently, nanoparticles having high sensitivity are coated on a surface of the semiconductor oxide nanofibers layer on which the first and second annealing processes are performed (S15). Here, nano-sized metal oxide particles or nano-sized metal catalyst particles may be used as the nanoparticles.

The nano-sized metal oxide particles may be coated on the nanofibers layer in a thin film form, and the nano-sized metal catalyst particles may be coated on the nanofibers layer in a dot form.

Oxides having high sensitivity to a specific gas may be used as the nano-sized metal oxide particles in order to improve sensitivity and selectivity. For example, the oxides may include one or more oxides selected from the group consisting of ABO₃-type perovskite oxides (BaTiO₃, metal-doped BaTiO₃, SrTiO₃, and BaSnO₃), ZnO, CuO, NiO, SnO₂, TiO₂, CoO, In₂O₃, WO₃, MgO, CaO, La₂O₃, Nd₂O₃, Y₂O₃, CeO₂, PbO, ZrO₂, Fe₂O₃, Bi₂O₃, V₂O₅, VO₂, Nb₂O₅, Co₃O₄ and Al₂O₃.

Also, the thin film by which the nano-sized metal oxide particles are coated may be formed to a thickness (100 nm or less) of a surface space charge layer in order to enhance electrical responsivity. The nano-sized metal oxide particles may be coated on the nanofibers layer in a thin film form using a physical or chemical deposition method such as a pulsed laser deposition method, a sputtering method, a sol-gel method, etc.

In addition, the nano-sized metal catalyst particles may be formed of one selected from the group consisting of Pt, Pd, Au, Ag, Ti, Cr, Al, Cu, Sn, Mo, Ru and In having high sensitivity to a specific gas in order to increase sensitivity and selectivity. The nano-sized metal catalyst particles may be coated on the nanofibers layer in a dot form using a physical deposition method such as a pulsed laser deposition method, a sputtering method, etc.

Afterwards, in order to enhance crystallization of the nanoparticles coated in a thin film or dot form and reactivity to a specific gas, a third annealing process may be performed at a temperature of 300□ or higher, and more preferably, 300□ to 500□, for 30 minutes to 10 hours.

While the detailed description of the present invention will be provided with reference to exemplary embodiments, the present invention is not limited to the exemplary embodiments below.

### EXAMPLE 1

Fabrication of a Semiconductor Oxide (ZnO) Nanofibers Layer for a Gas Sensor for Sensing Environmentally Harmful Gases

A metal oxide (ZnO) precursor, a poly(4-vinylphenol) (PVP) polymer and ethanol were weighed and mixed at a weight ratio of 5:3:1, and the mixed results were stirred at a temperature of 70□ for 10 hours to prepare a ZnO/PVP composite solution having a viscosity of 1200 cps. Then, the ZnO/PVP polymer composite solution was spun through an electrospinning device to fabricate ZnO/PVP polymer composite nanofibers on a SiO₂/Si substrate. Afterwards, a first annealing process was performed on the ZnO/PVP polymer composite nanofibers in the air at a temperature of 300□ for 30 minutes to volatilize ethanol. Subsequently, a second annealing process was performed on the ZnO/PVP polymer composite nanofibers at a temperature of 600□ for 30 minutes to obtain a semiconductor oxide (ZnO) nanofiber layer.

Characteristics of the ZnO/PVP polymer composite nanofibers and the ZnO nanofiber layer obtained in Example 1 were evaluated below.

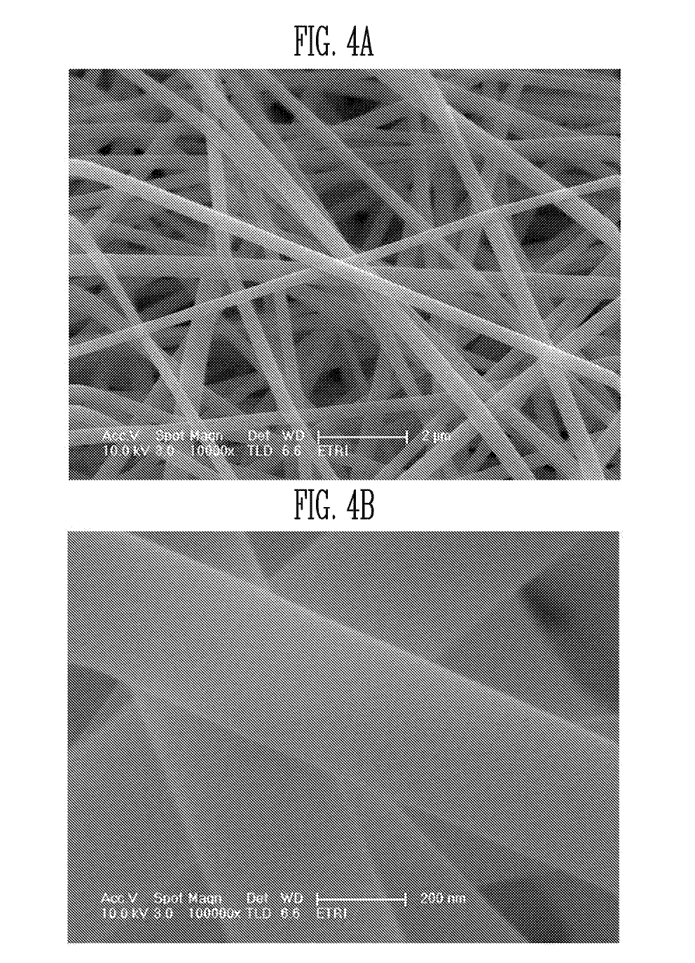

FIG. 4 is a scanning electron microscope (SEM) image of a surface of the ZnO/PVP polymer composite nanofibers obtained in Example 1.

Referring to FIG. 4, the ZnO/PVP polymer composite nanofibers fabricated on the SiO₂/Si substrate by electrospinning was formed to a diameter of 200 to 300 nm.

FIG. 5 is a SEM image of the semiconductor oxide (ZnO) nanofiber layer obtained in Example 1.

Referring to FIG. 5, a microscopic structure of the ZnO nanofibers layer fabricated by performing a second annealing process on the ZnO/PVP polymer composite nanofibers formed on the SiO₂/Si substrate at a temperature of 600□ for 30 minutes is illustrated, and the ZnO nanofibers layer was formed to a diameter of 30 to 70 nm. As confirmed from FIG. 5, the ZnO nanofibers layer has a one-dimensional structure in which ZnO nano-sized grains are connected to each other.

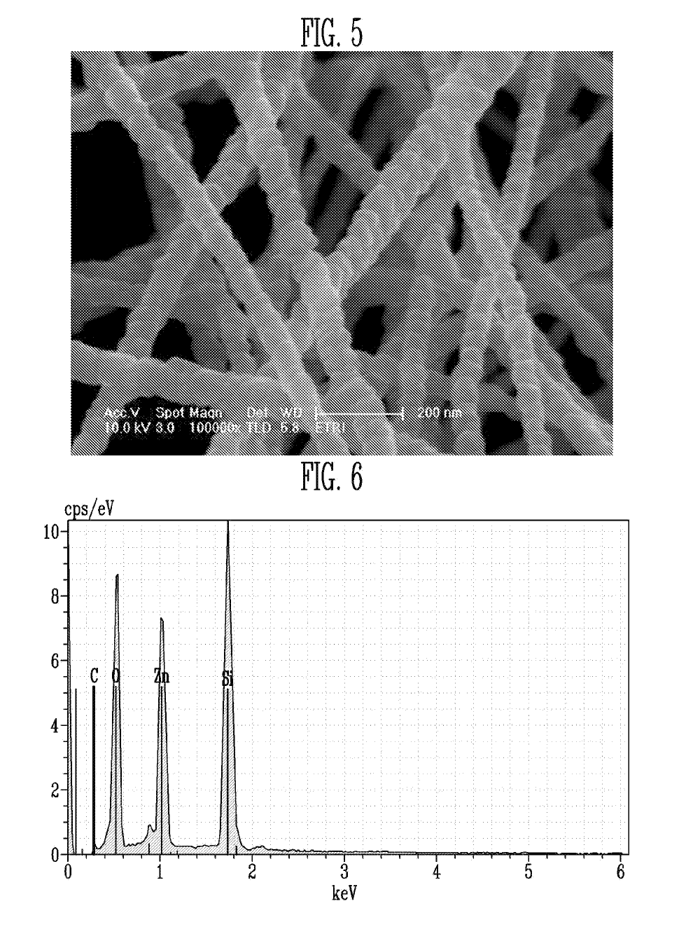

FIG. 6 illustrates a result of an energy dispersive X-ray spectroscopy (EDS) spectrum of the semiconductor oxide (ZnO) nanofibers layer obtained in Example 1. Referring to FIG. 6, in the oxide semiconductor (ZnO) nanofiber, it is confirmed that only Zn and O elements are observed.

FIG. 7 is a graph of θ-2θ X-ray diffraction patterns of the ZnO nanofiber obtained in Example 1.

As can be seen in FIG. 7, in a result of measuring X-ray diffraction of the semiconductor oxide (ZnO) nanofibers of Example 1, diffraction peaks of (100), (002), (101) and (102) were observed, and this means that polycrystalline ZnO nanofibers were formed.

### EXAMPLE 2

Fabrication of a Semiconductor Oxide (ZnO) Nanofiber Layer on which Nanoparticles for a Gas Sensor for Sensing Environmentally Harmful Gases are Coated

Using SnO₂ material, which is a gas sensor material having excellent gas response characteristics, a SnO₂ thin film was coated on a surface of the semiconductor oxide (ZnO) nanofibers obtained in Example 1 to a thickness of 20 nm at room temperature using a pulsed laser deposition method. Then, in order to crystallize the SnO₂ nano thin film coated on the surface of the semiconductor oxide (ZnO) nanofibers, an annealing process was performed at a temperature of 600□ for 10 minutes.

The semiconductor oxide (ZnO) nanofibers layer on which SnO₂ nanoparticles obtained in Example 2 were coated in a thin film form was evaluated to have the following characteristics.

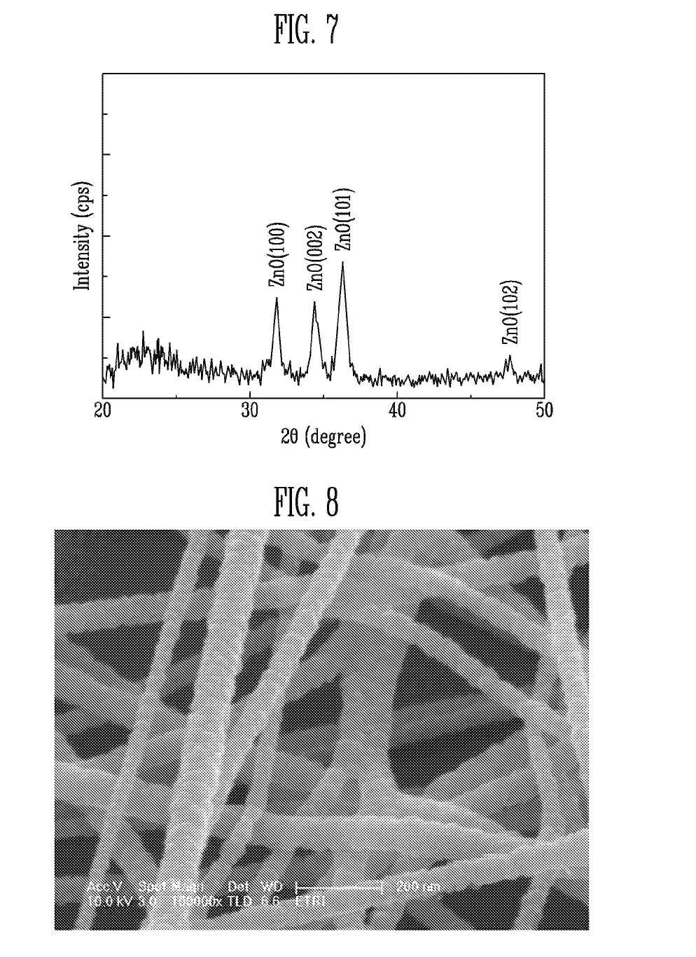

FIG. 8 is a SEM image of a surface of the ZnO nanofibers layer on which SnO₂ nanoparticles obtained in Example 2 are coated.

As can be seen from FIG. 8, the semiconductor oxide (ZnO) nanofibers obtained in Example 2 was formed to a diameter of 50 to 90 nm, and had a greater diameter than that of FIG. 5 obtained in Example 1. Further, the coated SnO₂ nanoparticles seems to have a thickness of about 20 nm.

Moreover, comparing FIG. 5 with FIG. 8, it is perceived that the semiconductor oxide (ZnO) nanofibers layer on which SnO₂ nanoparticles are coated is formed of smaller and denser nano-sized grains than that on which nanoparticles are not coated.

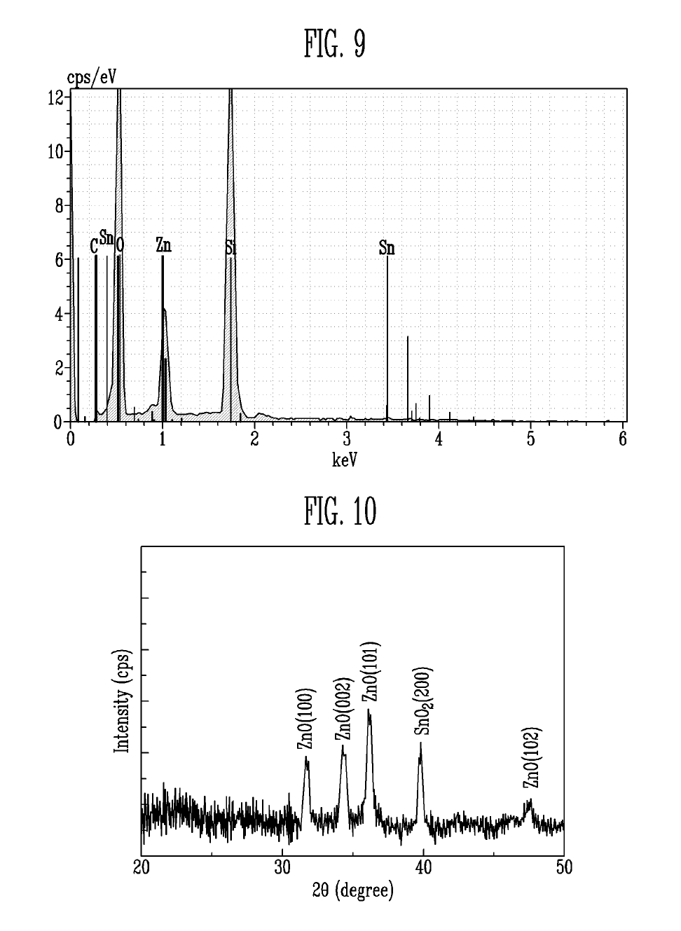

FIG. 9 illustrates a result of an EDS spectrum of the ZnO nanofiber layer on which SnO₂ nanoparticles obtained in Example 2 are coated.

Referring to FIG. 9, it is confirmed that only Zn, Sn and O elements are observed in the semiconductor oxide (ZnO) nanofibers layer on which the SnO₂ nanoparticles of Example 2 are coated.

FIG. 10 is a graph of a θ-2θ X-ray diffraction pattern of the ZnO nanofiber layer on which the SnO₂ nanoparticles obtained in Example 2 are coated. Not only were polycrystalline ZnO diffraction peaks of (100), (002), (101) and (102) observed, but also a polycrystalline SnO₂ diffraction peak of (200) was observed. Therefore, it can be confirmed that the SnO₂ nanoparticles were coated on the ZnO nanofibers layer.

### EXAMPLE 3

Gas Sensor for Sensing Environmentally Harmful Gases

An interdigital transducer metal electrode (Pt) was formed to a thickness of 100 nm on a quartz substrate formed to a thickness of 0.5 mm. Afterwards, a semiconductor oxide (ZnO) nanofibers layer was formed on the electrode metal in the same manner as Example 1, and SnO₂ nanoparticles formed to a thickness of 20 nm were coated on a surface of the semiconductor oxide (ZnO) nanofibers layer in the same manner as Example 2 to fabricate an ultra-sensitive nanofiber gas sensor for sensing environmentally harmful gases having the same structure as FIG. 1.

The gas sensor fabricated in Example 3 is evaluated to have the following gas response characteristics.

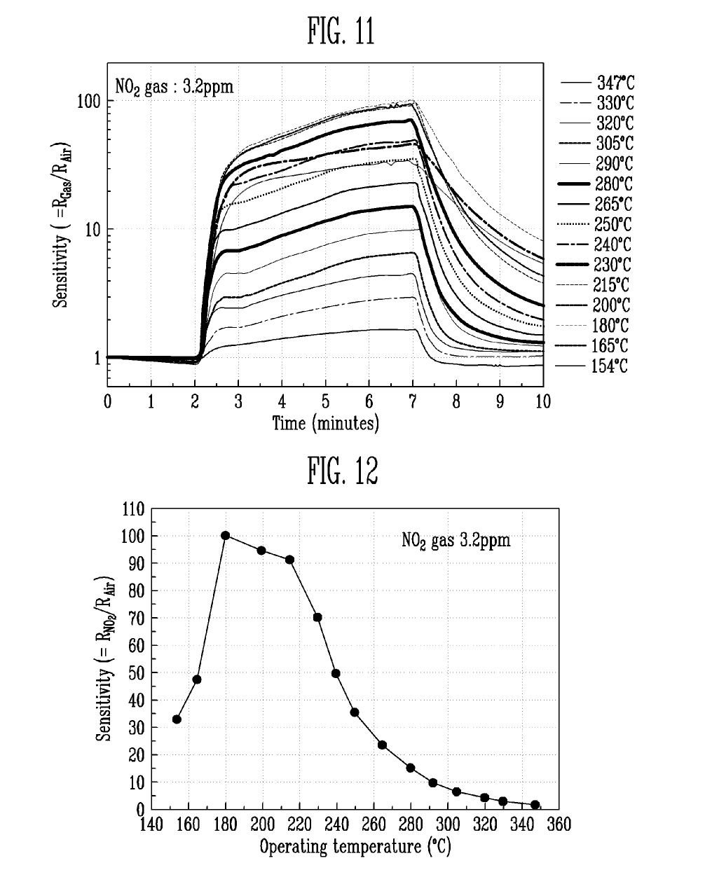

FIG. 11 is a graph illustrating a change in sensitivity to NO₂ gas reactions according to operating temperature and time of the gas sensor for sensing environmentally harmful gases fabricated in Example 3. According to FIG. 11, the sensitivity was obtained by measuring a resistance change in an NO₂ concentration of 3.2 ppm while changing a temperature from 154□ to 347□. The sensitivity of the gas sensor may be defined as a ratio of a resistance in an NO₂ gas atmosphere to a resistance in the air. According to FIG. 11, the sensitivity increased in proportion to the temperature, and while the sensitivity increased over time, it reduced at a certain point in time.

FIG. 12 is a graph illustrating sensitivity to NO₂ gas reactions according to operating temperature of the gas sensor for sensing environmentally harmful gases fabricated in Example 3. According to FIG. 12, with respect to an NO₂ gas having a concentration of 3.2 ppm, the best gas reaction characteristics were exhibited at a temperature of 180□ to 220□.

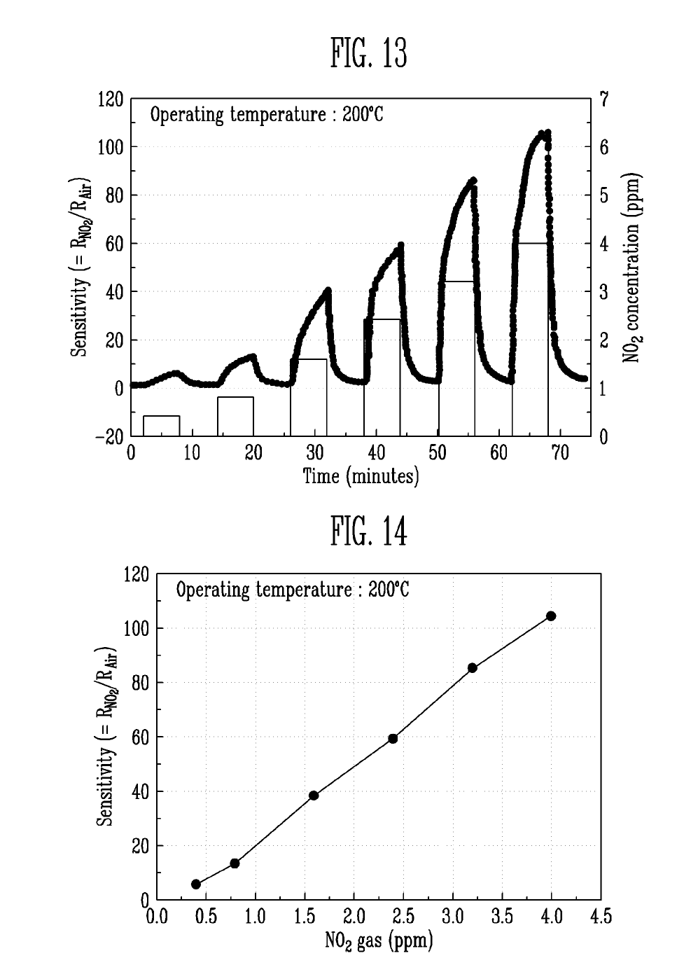

FIG. 13 is a graph of sensitivity versus the concentration of NO₂ gas of the gas sensor for sensing environmentally harmful gases fabricated in Example 3. According to FIG. 13, a change in sensitivity of the gas sensor was measured while varying the NO₂ gas concentration from 0.4 ppm to 4 ppm at an operating temperature of 200□, and it is observed that the sensitivity increases in proportion to the gas concentration.

FIG. 14 is a graph illustrating a change in sensitivity versus a change in NO₂ gas concentration of the gas sensor for sensing environmentally harmful gases fabricated in Example 3. According to FIG. 14, it is observed that as the NO₂ gas concentration increases, the sensitivity linearly increases.

In the present invention, nano-sized metal oxide or metal catalyst particles having high sensitivity are partially coated on a surface of the nanofibers having a large specific surface area, so that an semiconductor oxide nanofibers gas sensor having characteristics of ultra sensitivity, high selectivity, fast response and long-term stability can be provided.

Moreover, as a result of development of the semiconductor oxide nanofibers gas sensor having superior characteristics, the gas sensor can be applied to next-generation ubiquitous sensor systems and environmental monitoring systems, which require more accurate measurement and control of gases harmful to the environment.

In the drawings and specification, there have been disclosed typical exemplary embodiments of the invention and, although specific terms are employed, they are used in a generic and descriptive sense only and not for purposes of limitation. As for the scope of the invention, it is to be set forth in the following claims. Therefore, it will be understood by those of ordinary skill in the art that various changes in form and details may be made therein without departing from the spirit and scope of the present invention as defined by the following claims.

What is claimed is:

1. An ultra-sensitive gas sensor, comprising:
an insulating substrate;
a metal electrode formed on the insulating substrate; and
a semiconductor metal oxide nanofibers layer formed on the metal electrode and having nanoparticles of high sensitivity coated thereon.

2. The gas sensor of claim 1, wherein the insulating substrate is selected from the group consisting of an oxide single crystal substrate, a ceramic substrate, a silicon substrate on which an insulating layer is formed, and a glass substrate.

3. The gas sensor of claim 1, wherein the metal electrode is formed of one or more elements selected from the group consisting of Pt, Pd, Ag, Au, Ni, Ti, Cr, Al, Cu, Sn, Mo, Ru and In.

4. The gas sensor of claim 1, wherein the metal oxide constituting the semiconductor metal oxide nanofibers layer is formed of one or more oxides selected from the group consisting of ABO₃-type perovskite oxides (BaTiO₃, metal-doped BaTiO₃, SrTiO₃, and BaSnO₃), ZnO, CuO, NiO, SnO₂, TiO₂, CoO, In₂O₃, WO₃, MgO, CaO, La₂O₃, Nd₂O₃, Y₂O₃, CeO₂, PbO, ZrO₂, Fe₂O₃, Bi₂O₃, V₂O₅, VO₂, Nb₂O₅, Co₃O₄ and Al₂O₃, and each nanofiber constituting the nanofibers layer is formed to a diameter of 1 to 100 nm.

5. The gas sensor of claim 1, wherein the nanoparticle coated on the nanofiber layer is a nano-sized metal oxide particle or metal catalyst particle having high sensitivity to a specific gas.

6. The gas sensor of claim 5, wherein the metal oxide is formed of one or more oxides selected from the group consisting of ABO₃-type perovskite oxides (BaTiO₃, metal-doped BaTiO₃, SrTiO₃, and BaSnO₃), ZnO, CuO, NiO, SnO₂, TiO₂, CoO, In₂O₃, WO₃, MgO, CaO, La₂O₃, Nd₂O₃, Y₂O₃, CeO₂, PbO, ZrO₂, Fe₂O₃, Bi₂O₃, V₂O₅, VO₂, Nb₂O₅, Co₃O₄ and Al₂O₃, and the metal includes one or more elements selected from the group consisting of Pt, Pd, Ag, Au, Ti, Cr, Al, Cu, Sn, Mo, Ru and In.

7. A method of fabricating an ultra-sensitive gas sensor, comprising:
forming a metal electrode on an insulating substrate;
electrospinning a composite solution in which a metal oxide, a polymer material and a solvent are mixed on the metal electrode to form an oxide/polymer composite nanofibers layer;
performing a first annealing process on the composite nanofibers layer to remove the solvent;
performing a second annealing process on the composite nanofibers layer from which the solvent is removed to form an semiconductor oxide nanofibers layer;
coating nanoparticles on a surface of the semiconductor oxide nanofibers layer; and
performing a third annealing process on the semiconductor oxide nanofibers layer on which the nanoparticles are coated.

8. The method of claim 7, wherein the metal oxide includes one or more oxides selected from the group consisting of ABO₃-type perovskite oxides (BaTiO₃, metal-doped BaTiO₃, SrTiO₃, and BaSnO₃), ZnO, CuO, NiO, SnO₂, TiO₂, CoO, In₂O₃, WO₃, MgO, CaO, La₂O₃, Nd₂O₃, Y₂O₃, CeO₂, PbO, ZrO₂, Fe₂O₃, Bi₂O₃, V₂O₅, VO₂, Nb₂O₅, Co₃O₄, and Al₂O₃ precursors, the polymer includes one or more materials selected from the group consisting of polyvinylphenol (PVP), polyvinyl alcohol (PVA), polyvinyl acetate (PVAc), polystyrene (PS), polyethylene oxide (PEO), polyether urethane (PU), polycarbonate (PC), poly-L-Lactides (PLLA), polyvinyl carbazole (PVC), polyvinyl chloride (PVC), polycaprolactam, polyethylene terephthalate (PET), and polyethylene naphthalate (PEN), and the solvent includes one or more materials selected from the group consisting of ethanol, acetone, dimethylformamide (DMF), tetrahydrofuran (THF), isopropyl alcohol (IPA), water, chloroform, formic acid, diethyl formamide (DEF), dimethylacetamide (DMA), dichloromethane, toluene, and acetic acid.

9. The method of claim 7, wherein the first annealing process is performed around a glass transition temperature of a polymer material, the second annealing process is performed at a temperature of about 300 to about 800° C., and the third annealing process is performed at a temperature of about 300 to about 600° C.

10. The method of claim 7, wherein the nanoparticles are a nano-sized metal oxide or metal catalyst particle.

11. The method of claim 10, wherein the nano-sized metal oxide particle is coated on a surface of the semiconductor oxide nanofibers layer in a thin film form through a physical or chemical deposition means, and the nano-sized metal catalyst particle is coated on the surface of the semiconductor oxide nanofibers layer in a dot form through a physical or chemical deposition means.

12. The method of claim 10, wherein the nano-sized metal oxide includes one or more oxides selected from the group consisting of ABO₃-type perovskite oxides (BaTiO₃, metal-doped BaTiO₃, SrTiO₃, and BaSnO₃), ZnO, CuO, NiO, SnO₂, TiO₂, CoO, In₂O₃, WO₃, MgO, CaO, La₂O₃, Nd₂O₃, Y₂O₃, CeO₂, PbO, ZrO₂Fe₂O₃, Bi₂O₃, V₂O₅, VO₂, Nb₂O₅, Co₃O₄ and Al₂O₃, and the nano-sized metal catalyst includes one or more elements selected from the group consisting of Pt, Pd, Ag, Au, Ti, Cr, Al, Cu, Sn, Mo, Ru and In.
